(19) United States
(12) Patent Application Publication
(10) Pub. No.: US 2004/0100917 A1
(43) Pub. Date: May 27, 2004

(54) Coordinator device election process for wireless sensor networks

(76) Inventors: Matthew R. Perkins, Sunrise, FL (US); Neiyer S. Correal, Cooper City, FL (US); Jian Huang, Coral Springs, FL (US); Yan Huang, Weston, FL (US)

Correspondence Address: Barbara R. Doutre, Motorola, Inc., Law Department, 8000 West Sunrise Boulevard, Fort Lauderdale, FL, 33322, US

(21) Appl. No.: 10/304,279

(22) Filed: Nov. 26, 2002

(51) Int. Cl. G08C 17/00

(52) U.S. Cl. 370/311; 370/310.2

(57) ABSTRACT

An efficient coordinator device election process (600) that reduces the total power consumed during network initialization is provided. An initialization message propagates throughout a cluster of nodes. The initialization message contains a timing variable (604). Each node generates a random number (608) in response to receiving the initialization message. Each node sends a request for coordinator status to its neighboring nodes when its random number matches the timing variable (612). If the status request is detected (614) by the neighboring nodes, then the neighboring nodes become slave devices to the sender node (i.e. the coordinator device).

### TECHNICAL FIELD

This invention relates in general to wireless sensor networks and more particularly to battery life conservation means within such networks.

### BACKGROUND

Wireless Sensor Network technologies are finding their way into applications like precision agriculture, asset tracking, inventory management, and supply chain management. All of these applications require a network that can self-organize, operate efficiently and boast improved battery life. These self-organizing networks typically comprise nodes where each node is formed of a low cost radio frequency (RF) transceiver, controller and memory.

To meet the efficiency and battery life needs of these systems, network designers have proposed a network operating architecture whereby the nodes sleep for long periods of time and wake up only to transmit or receive messages. Unfortunately, the power that is conserved during these low duty cycle operations is often consumed by the network initialization algorithms that are needed to guarantee that the network is autonomous and self-organizing. In particular, the algorithms that are used to elect synchronizing agents or coordinating devices (described below) are inefficient due to the number of communications required to establish a uniform and stable distribution of devices throughout the network.

Designing wireless sensor networks to be power efficient in normal operations and during network setup is a challenging task. Most of the power efficient solutions utilize a dedicated device called a coordinating device, to act as a mediator for all communications. These coordinating devices are distributed through the network such that every node in the network is in range of at least one coordinating device. The coordinating devices take communication requests and distribute timing instructions that facilitate node communications. Insuring that a network has a uniform distribution of coordinating devices is typically done using an election process where nodes throughout the network vote, based on some criterion, and elect the “most capable” node as the coordinating device.

Two of the most popular election processes used today are called “lowest ID” (LID) and “highest degree” (HD) election. Unfortunately, the LID process can cause node isolation and can require a significant amount of messaging overhead in order to resolve disconnected network issues. The highest degree election process, on the other hand, does not have issues with node isolation but can require a significant amount of overhead in order to determine which nodes have the highest degree of connectivity. In any case, both the LID and the HD election algorithms can be expensive in terms of network-setup overhead and power consumption.

Accordingly, there is a need for an efficient coordinator election process that can reduce the total power consumed during network initialization while maintaining algorithm simplicity and requiring a negligible amount of messaging overhead.

### BRIEF DESCRIPTION OF THE DRAWINGS

The features of the present invention, which are believed to be novel, are set forth with particularly in the appended claims. The invention, together with further objects and advantages thereof, may best be understood by reference to the following description, taken in conjunction with the accompanying drawings, in the several figures of which like reference numerals identify like elements, and in which:

FIG. 1 is a representation of a wireless network distribution with a node selected to initiate a first initialization message in accordance with the present invention;

FIG. 2 illustrates how the cluster of nodes of FIG. 1 might propagate the node initialization message throughout the network in accordance with the present invention;

FIG. 3 is a table representing an example of each node of FIG. 1 picking a random time to compete for coordinator status in accordance with the present invention;

FIG. 4 is an example of overlapping coverage areas and a corresponding table of coordinator devices elected in accordance with the coordinator election process of the present invention;

FIG. 5 shows an example of simulation results achieved using the coordinator election process of the present invention; and

FIG. 6 is a more detailed flow diagram of the coordinator device election process in accordance with the present invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

In accordance with the present invention, a method for electing coordination devices in a wireless network is provided and described in detail below. The coordinating devices operate by scheduling communication rendezvous between nodes in conjunction with network timing and synchronization. The coordination device election process of the present invention is a very efficient process that reduces the total power consumed during network initialization while maintaining process simplicity and using only a negligible amount of messaging overhead.

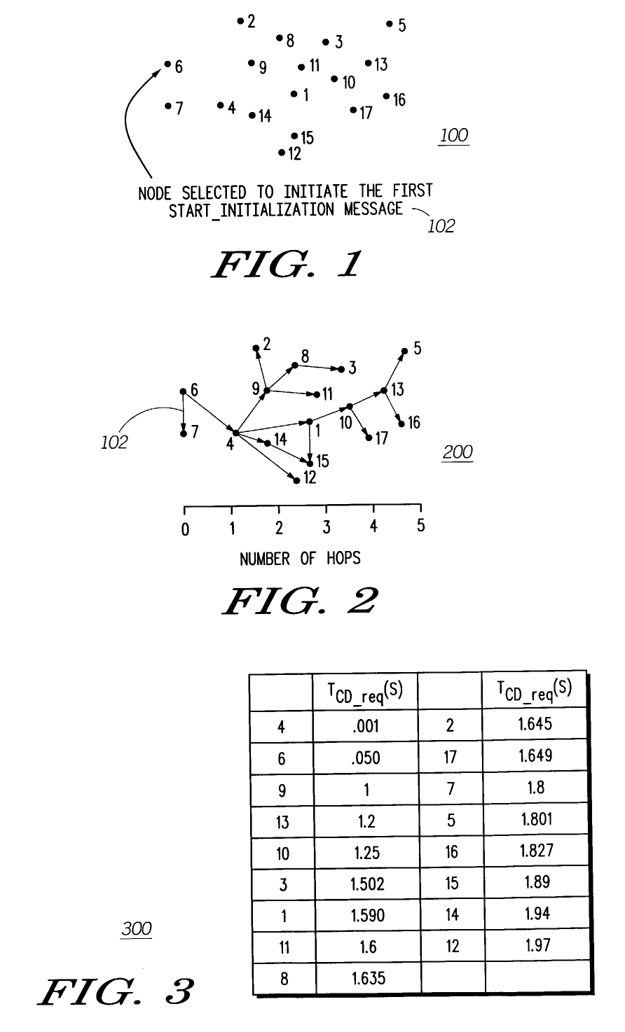

To illustrate how the coordination device election process of the present invention operates, an example scenario is provided throughout FIGS. 1-5 in which a plurality of nodes are deployed into an environment. FIG. 1 shows an example of a wireless network distribution 100 of a plurality of nodes labeled by node designators 1-17 which are waiting to start the election process by keeping their receivers powered on. In accordance with the present invention, the coordinator election process is conducted as follows:

One node out of the plurality of nodes is selected to initiate a message to start initialization that gets broadcast to all of the neighboring nodes. In FIG. 1, node 6 initiates the first start node initialization message (START_INITIALIZATION) 102. In accordance with a preferred embodiment of the invention, the node initialization message 102 contains a timing variable that indicates the maximum time allotted for network initialization. In this example the timing variable (INIT_STOP_TIME) being used is two (2) seconds. The timing variable will also be referred to as the stop time. Alternatively, if the timing variable information is already known, then it need not be stored in the initialization message. For example predetermined timing variable information may be stored at the individual node and simply triggered by the initialization message.

FIG. 2 illustrates how the plurality of nodes might propagate the node initialization message 102 throughout the network 100. In this example, five hops were used to propagate the initialization message 102 to nodes 5 and 16.

In accordance with the present invention, upon receiving the initialization message, each of the plurality of nodes starts a timer, initialized to a predetermined start time, and randomly picks a number between the start time and the stop time. The start time may be unique for each node if desired. In this example, upon receiving the initialization message 102, each of nodes 1-17 starts a timer, initialized to zero, and randomly picks a number between zero (0) and the stop time of two (2) seconds. This random time is used to compete for coordinator status.

FIG. 3 is a table representing an example of each node of FIG. 1 picking a random time to compete for coordinator status in accordance with the process of the present invention. Timetable 300 shows, in absolute time, the random number value selected by each node 1-17 of the network 100. It is noted, that an absolute time reference need not be known by all devices. To follow an example, node 10 selected a random value of 1.25 seconds, node 11 selected a random value of 1.6 seconds, and node 12 selected a random value of 1.97 seconds. All of the random numbers in timetable 300 fall within the initialization stop time of two seconds.

In accordance with the present invention, when the timer of a node matches its internally generated random number, the node transmits a request for coordinator status (RCS) message that gets broadcast to its neighboring nodes. Upon receiving a request for coordinator status message, the receiving node relinquishes its right to become a coordinating device and becomes a slave device to the node that transmitted the request (i.e. the coordinator device).

The receiving node may (but is not required to) send an acknowledgement (ACK) message to the source of RCS message. If an acknowledgment is sent, each node preferably utilizes some type of collision avoidance scheme, for example a Medium Access Contention (MAC) scheme like Carrier Sense Multiple Access Collision Avoidance (CSMA-CA). If a node receives more than one coordinator status request message, it may return multiple acknowledgment messages, each one being addressed to a different coordinator device.

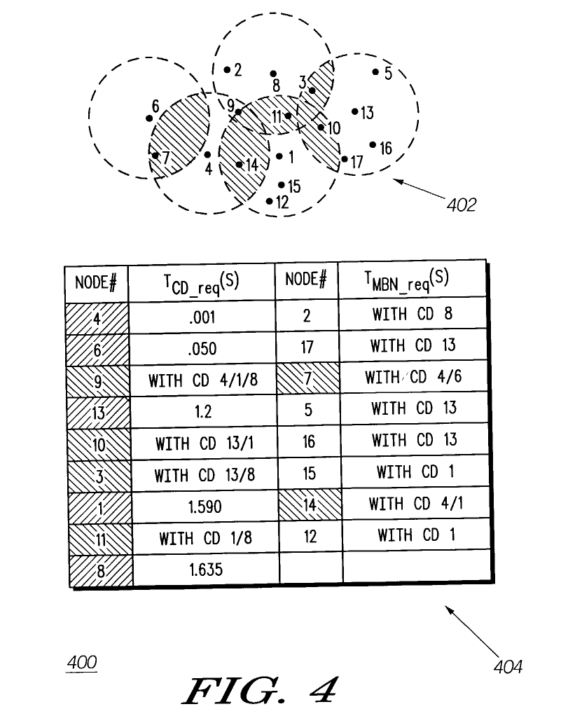

Once the timer reaches the stop time, the nodes stop competing for coordinator status, conclude all initialization communications, and return to regular network operations. FIG. 4 shows results 400 both as a diagram 402 and in a timetable 404 indicating the end results of a coordinator election process for nodes 1-17. As can be seen from Table 400, nodes 4, 6, 13, 1, and 8 were elected as coordination devices. Note that the nodes with the earliest random number times, that were not located within the coverage area of a node that had an even earlier random number time, were elected as coordination devices (i.e. nodes 4, 6, 13, 1, and 8).

As seen from diagram 402, nodes 9, 10, 3, 11, 7, and 14 are located in overlapping coverage areas (indicated by the hatched lines) and thus become slave devices to two or more coordinating devices. For example, node 9 originally competes for election but only has a coordinator status request coming due at T_{CDreq}=1 second. When node 4 requests coordinator status at timeT_{CDreq}=0.O01 seconds, node 9 removes itself from competing for election and actually becomes a slave device to node 4. Node 1 requests coordinator status at timeT_{CDreq}=1.590 seconds which is granted by node 9. Thus, node 9 becomes a slave device to both nodes 4 and 1. Node 8 requests coordinator status at time T_{CDreq}=1.635 seconds and node 9 becomes a slave device to node 8 as well. Thus, node 9 has become a slave device to coordinating devices 4, 1, and 8. The timer may run in the opposite direction (STOP TIMES to ZERO) if desired. Nodes may or may not send acknowledgments, depending on the application.

Following another example from diagram 402 and table 404, node 11 falls in overlapping transmit areas and competes for election with a coordinator request status time of T_{CDreq}=1.6 seconds. However, node 1 requests coordinator status at T_{CDreq}=1.590 seconds forcing node 11 to give up its status request. Node 8 then sends a status request at T_{CDreq}=1.635 seconds making node 11 operate as a slave device to both nodes 8 and 1.

Nodes falling within non-overlapping transmit coverage areas with higher coordinator request times preferably align with previously elected coordinators. For example, node 12 with a status request time of T_{CDreq}=1.97 seconds becomes a slave device to node 1 which is within the same transmit area. Node 2 having a status request time of T_{CDreq}=1.645 seconds becomes a slave device to node 8 having a status request time of T_{CDreq}=1.635 seconds, because they are in the same transmit area and node 8 was first to transmit an RCS.

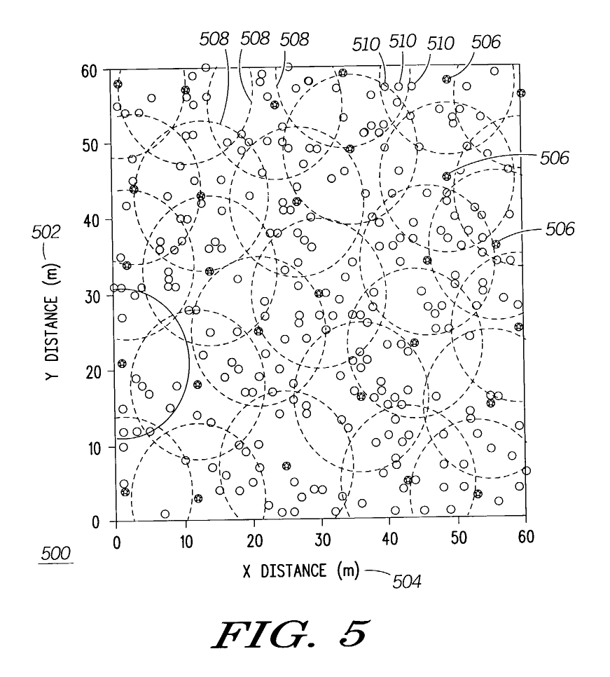

FIG. 5 shows an example of simulation results 500 achieved for a wireless network utilizing the coordinator device election process of the present invention. For these particular results, the process was run for 300 nodes in a 60 m×60 m coverage area and assuming that each node had a 10 m transmission range. The coverage area is indicated by designator 504 along the x-axis (x distance) and designator 502 along the y-axis (y distance). Designator 506 is pointing to a plurality of coordinating devices elected in accordance with the coordinator election process of the present invention. The dashed lines indicate coordinator device transmission areas 508. Designator 510 is pointing to a plurality of slave nodes. It was assumed that each node of the plurality of nodes 510 had an omni-directional transmission pattern. As seen from the results, the elected coordinator devices 506 are nearly uniformly distributed and no node is left stranded or unconnected. Furthermore, the entire process requires only one transmission from regular nodes 510 and several low duty cycle transmissions from elected coordination devices 506. Thus, an efficient coordinator election process with low overhead has been provided.

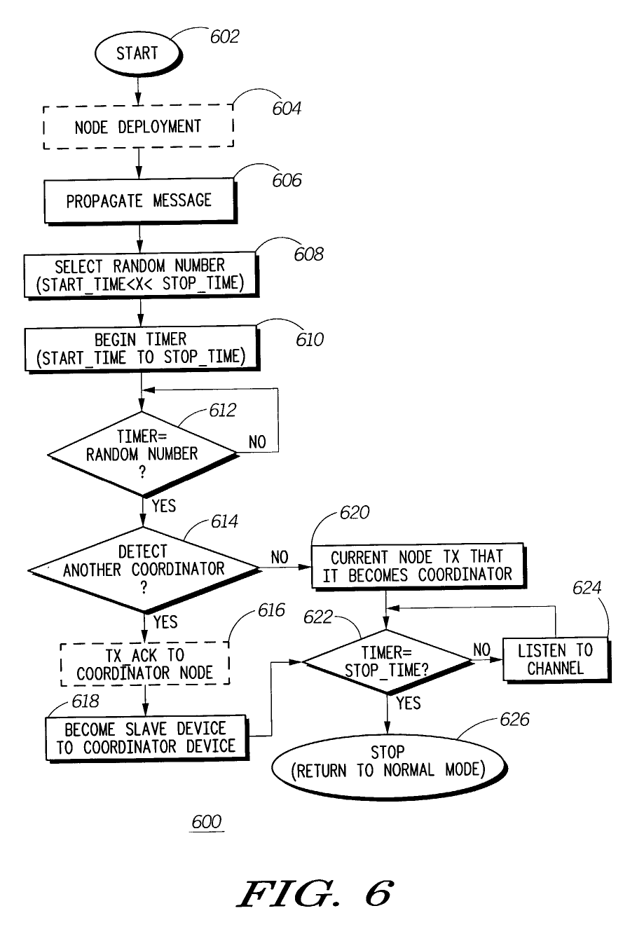

FIG. 6 is a detailed flow diagram of the process for electing coordinator devices in a wireless network system in accordance with the present invention. Process 600 begins at step 602 possibly with a network deployment step 604 in which a plurality of nodes are distributed within an environment. Note that if the nodes have already been deployed, step 604 becomes unnecessary. In accordance with the present invention, an initialization message is propagated throughout the plurality of nodes at step 606, the message preferably including a stop time, wherein the stop time may be unique for each node if desired. The step of selecting a random number between the start and stop times at each node occurs at step 608. A timer begins to run at step 610 and will track the elapsed time between the start time and the stop time for each node. Step 612 checks the timer value versus the random number and continues to compare them until the elapsed time of the timer value equals the random number. Once the timer value at step 612 equals the random number, the process moves ahead to step 614 where the network detects whether another node has sought to be a coordinator device during the elapsed time. If another coordinator has been sensed at any time throughout the elapsed time, then the receiving node preferably transmits an acknowledgement back to the source node at step 616. As mentioned earlier acknowledgements are not mandatory. The recipient node of the request becomes a slave device to the source/sender of the request (i.e. the coordinator device) at step 618. If no other coordinator is sensed at step 614, then the current node transmits that it has become the coordinator device at step 620. Once a slave device is established at step 618 or a coordinator device is established at step 620, the process continues to step 622 where the timer is compared to the stop time. If the stop time has not been reached at step 622, the process proceeds to step 624 where the network listens to the channel and continues to monitor the timer at step 622A variety of process activities can take place during the listen to channel step 624. This step can include listening for acknowledgements of requests and acknowledging back again that a node will become a coordinator device. Step 624 can also include coordinator contention resolution processes to resolve conflicts when two nodes select the same random time.

Accordingly, there has been provided, in accordance with the present invention, a wireless network system in which coordinator devices are elected by propagating an initialization message, selecting a random number based on the initialization message, tracking elapsed time, determining when the tracked elapsed time equals the selected random number; detecting whether a coordinator device status request has been received at any time throughout the tracked elapsed time; and becoming a coordinating device if no request has been detected and becoming a slave device if a request has been detected.

The coordinator device election process of the present invention can be applied to many different markets. Some of these markets include, logistics, asset management, inventory management, building management, home automation, disaster recovery and wartime intelligence to name a few. The energy efficient and effective initialization process provides a means of achieving long lasting battery life in wireless sensor networks.

The wireless network utilizing the initialization process of the present invention provides advantages over existing systems such as the Backbone nodes system. Backbone nodes are very different from coordination nodes as they do not schedule communication rendezvous between nodes, nor do they perform any kind of network timing or synchronization. Both of these aspects are exhibited by the coordination device and are extremely valuable to wireless sensor networks. Having an efficient process that elects these devices and forms a fully connected network as described by the coordinator device election process of the present invention is invaluable for wireless sensor applications.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for electing coordinator devices in a wireless network system having a plurality of nodes, comprising the steps of:
initializing the network by:
propagating an initialization message throughout the plurality of nodes;
generating a random number for each node upon receiving the initialization message;
tracking the elapsed time;
transmitting a request to be a coordinator device from one of the plurality of nodes when the elapsed time reaches the random number of one of the plurality of nodes;
receiving the request at a receiving node; and
becoming the coordinator device at the transmitting node.

2. A method for electing a coordinator device in a wireless network system having a plurality of nodes, comprising the steps of:
selecting a random number between a predetermined start time and stop time;
tracking elapsed time;
comparing the elapsed time versus the random number until the elapsed time is equal to the random number;
transmitting, from a source node, a request to be a coordinator device when the elapsed time is equal to the random number;
detecting the request at a receiving node, the receiving node becoming a slave device to the transmitting node.

3. The method of claim 2, further including the step of transmitting an acknowledgement from the receiving node back to the transmitting node.

4. A method of initializing a wireless network system having a plurality of nodes, comprising the steps of:
at each node:
propagating an initialization message;
selecting a random number based on the initialization message;
tracking elapsed time;
determining when the tracked elapsed time equals the selected random number;
detecting whether a coordinator device status request has been received at any time throughout the tracked elapsed time, once the tracked elapsed time equals the random number; and
becoming a coordinating device if no request has been detected and becoming a slave device if a request has been detected.

5. A wireless network system, comprising:
a plurality of nodes;
one node out of the plurality of nodes initiating a node initialization message, the node initialization message containing a timing variable indicating an initialization stop time for network initialization;
the plurality of nodes propagating the initialization message throughout the wireless network;
each node internally generating a random number between a predetermined start time and the initialization stop time, the random number determining when each node competes for coordinator device status;
each node having a timer for tracking elapsed time and comparing the elapsed time to the internally generated random number, each node competing for coordinator device status by transmitting a coordinator status request to neighboring nodes when the elapsed time matches the random number; and
a receiving node, upon receiving a coordinator status request, removing itself from competing for coordinator device status.

6. A wireless network system as described in claim 5, wherein the receiving node becomes a slave device to a coordinating device, the coordinating device being the device that transmitted the coordinator status request that was received by the receiving node

7. A wireless network system as described in claim 6, wherein a slave device operates as slave device to more than one coordinating device.

8. The wireless network of claim 5, wherein the receiving node sends an acknowledgment to the node that transmitted the coordinating status request.

9. A wireless network system, comprising:
a plurality of nodes propagating an initialization message throughout the network, the initialization message containing a timing variable;
each node generating a random number in response to receiving the initialization message; and
each node sending a request for coordinator status to its neighboring nodes when its random number matches the timing variable, the neighboring nodes becoming slave devices, in response to detecting the request.

10. A wireless network system as described in claim 9, wherein a slave device operates as slave device to more than one coordinating device.

11. A wireless network, comprising:
a plurality of nodes dispersed over a predetermined coverage area, the plurality of nodes electing, amongst themselves, coordinating devices that operate over overlapping transmission areas, and wherein each node operates as a slave device to at least one coordinating device.
